(19) United States
(12) Patent Application Publication
(10) Pub. No.: US 2025/0065693 A1
(43) Pub. Date: Feb. 27, 2025

(54) INTEGRATED THERMAL MANAGEMENT CIRCUIT FOR VEHICLE

(71) Applicants: Hyundai Motor Company, Seoul (KR); Kia Corporation, Seoul (KR)

(72) Inventors: Uk Il Yang, Yongin (KR); Man Ju Oh, Yongin (KR); Ki Mok Kim, Hwaseong (KR); Sang Shin Lee, Suwon (KR)

(21) Appl. No.: 18/828,746

(22) Filed: Sep. 9, 2024

Related U.S. Application Data
(62) Division of application No. 17/841,123, filed on Jun. 15, 2022.

(30) Foreign Application Priority Data
Jul. 28, 2021 (KR) 10-2021-0099297

(51) Int. Cl. B60H 1/32; B60H 1/00

(52) U.S. Cl. CPC B60H 1/3228; B60H 1/00278

(57) ABSTRACT

A vehicle thermal management circuit includes a refrigerant line configured to cause refrigerant to flow in the order of a compressor, an indoor condenser and an outdoor heat exchanger of an indoor air-conditioning apparatus, a battery cooling line configured to circulate cooling water between a battery and a battery radiator or between the battery and a chiller unit, an electric part cooling line configured to circulate cooling water between an electronic driving unit and an electric part radiator or between the driving unit and the chiller, and an accumulation unit located at an upstream point of the compressor on the refrigerant line, includes an expansion valve and a refrigerant heater, and is configured to receive the refrigerant discharged from the chiller or the evaporator and provide the received refrigerant to the compressor or to expand or heat the refrigerant and provides the expanded or heated refrigerant to the compressor.

### CROSS REFERENCE TO RELATED APPLICATION

The present application is a divisional of U.S. patent application Ser. No. 17/841,123 filed on Jun. 15, 2022, which claims under 35 U.S.C. § 119 (a) the benefit of Korean Patent Application No. 10-2021-0099297, filed on Jul. 28, 2021 in the Korean Intellectual Property Office, the entire contents of which are incorporated herein by reference.

### BACKGROUND

### Technical Field

Embodiments of the present disclosure relate to an integrated thermal management circuit for a vehicle. A battery chiller and an electric part chiller are respectively provided, or an integrated chiller integrating a battery chiller and an electric part chiller is provided, to reduce the number of parts and reduce costs, and in which heating and battery temperature rise, etc. through a heat pump may be independently performed according to a thermal management mode of the vehicle through an accumulating unit provided with an accumulation unit, an expansion valve and a refrigerant heater.

### Description of the Related Art

Recently, the number of registered, eco-friendly vehicles is on the rise due to the combination of policies for expanding the supply of eco-friendly vehicles and preference for high fuel efficiency vehicles. An electric vehicle does not use petroleum fuel and an internal combustion engine but uses an electric battery and an electric motor to operate, and is therefore an eco-friendly vehicle. An electric vehicle has a system which drives the vehicle by rotating the electric motor with electricity stored in a battery. Accordingly, electric vehicles have advantages of zero emission, low noise, and high energy efficiency.

In the case of a petroleum fueled vehicle, a heating system for a passenger compartment is operated using waste heat of the engine. However, since an electric vehicle does not have an engine, it has a system which operates a heater using electricity. Accordingly, the electric vehicle has a problem in that the heater consumes energy stored by the electric battery, significantly decreasing a driving distance upon heating.

A battery module needs to be used in an optimal temperature environment to maintain optimal performance and a long lifespan. However, it is difficult to use the battery module in the optimal temperature environment due to heat generated during driving and an external temperature variation.

In order to solve this problem, a method for combining an air-conditioning system and a thermal management system of the electric vehicle is being actively discussed.

In the case of a conventional thermal management circuit using an integrated chiller which exchanges heat with an electronic driving unit and a battery, a water heater is used to raise the temperature of the battery in severe cold environment. However, the water heater is generally connected in series with the battery on a battery cooling water line in the same manner as the integrated chiller, heats cooling water to be introduced into the battery, and supplies the heated cooling water to the battery. Therefore, when the temperature of the battery is raised through the water heater, the waste heat of the electronic driving unit cannot be recovered though the integrated chiller to be used for indoor heating of the vehicle. Thus, there is a problem in that the heat management efficiency of the vehicle deteriorates.

Accordingly, there is a need to develop an integrated thermal management circuit capable of implementing various operation modes such as battery temperature rise and indoor heating through a refrigerant heater even without a water heater or a positive temperature coefficient (PTC) heater.

The foregoing discussion is intended merely to aid in the understanding of the background of the present disclosure, and is not intended to mean that the present disclosure falls within the purview of the related art that is already known to those skilled in the art.

### SUMMARY

Embodiments of the present disclosure are proposed to solve the above problems, and an object of the present disclosure is to provide an integrated thermal management circuit for a vehicle. A battery chiller and an electric part chiller are provided, respectively or an integrated chiller integrating the battery chiller and the electric part chiller is provided, to reduce the number of parts and reduce costs, and in which heating and battery temperature rise, etc. through a heat pump may be independently performed according to a thermal management mode for the vehicle through an accumulating unit provided with an accumulation unit, an expansion valve and a refrigerant heater.

An integrated thermal management circuit for a vehicle according to an embodiment of the present disclosure includes a refrigerant line which causes a refrigerant to flow in the order of a compressor, an indoor condenser of an indoor air-conditioning apparatus and an outdoor heat exchanger. The refrigerant discharged from the outdoor heat exchanger is introduced into the compressor after passing through a chiller unit or an evaporator of the indoor air-conditioning apparatus. The integrated thermal management circuit also includes a battery cooling line that is configured to circulate cooling water between a battery and a battery radiator or between the battery and the chiller unit. The integrated thermal management circuit further includes an electric part cooling line that is configured to circulate the cooling water between an electronic driving unit and an electric part radiator or between the electronic driving unit and the chiller unit. The integrated thermal management circuit additionally includes an accumulation unit, which is located at an upstream point of the compressor on the refrigerant line, includes an expansion valve and a refrigerant heater, and is configured to receive the refrigerant discharged from the chiller unit or the evaporator and provide the received refrigerant to the compressor or to expand or heat the refrigerant and provide the expanded or heated refrigerant to the compressor.

The chiller unit includes an electric part chiller and a battery chiller which are connected in parallel. Cooling water of the battery cooling line is circulated through the battery chiller, and cooling water of the electric part cooling line is circulated through the electric part chiller.

The refrigerant discharged from the compressor on the refrigerant line is branched for introduction into a temperature-rise control valve which is located at an upstream point of the battery chiller. The temperature-rise control valve may be configured to close a port for the outdoor heat exchanger in a temperature rise mode of the battery.

The chiller unit includes an integrated chiller which is formed with a plurality of flow paths. Cooling water of the battery cooling line, cooling water of the electric part cooling line, and the refrigerant of the refrigerant line are circulated through the integrated chiller through the respective independent flow paths.

In the refrigerant line, the expansion valve is located at an upstream point of the outdoor heat exchanger, an upstream point of the chiller unit or an upstream point of an evaporation line. The refrigerant, which passes through the expansion valve of the upstream point of the outdoor heat exchanger, the upstream point of the chiller unit, or the upstream point of the evaporation line, is selectively expanded depending on a cooling and heating mode of the vehicle.

When the battery temperature rise mode is performed in the battery cooling line, the electric part waste heat recovery mode of the electronic driving unit is performed in the electric part cooling line, and the refrigerant line performs indoor heating through the waste heat of the electronic driving unit.

When indoor heating is performed through outdoor air heat absorption or indoor heating through the recovery of electric part waste heat of the electronic driving unit, the accumulation unit heats the refrigerant which is introduced into the accumulation unit through the refrigerant heater.

Both indoor heating and temperature rise of the battery through electric part waste heat recovery of the electronic driving unit are performed together, after the accumulation unit expands the refrigerant that is introduced into the accumulation unit through the expansion valve, and after the accumulation unit heats the expanded refrigerant through the refrigerant heater.

On the battery cooling line, a first control valve is located at a point which is joined from a downstream point of the battery radiator and the battery chiller to an upstream point of the battery. The first control valve is configured to adjust flow of the cooling water that is introduced into the battery, by opening and closes a port for the battery radiator or a port for the battery chiller, depending on a thermal management mode of the battery.

The first control valve is a three-way valve and is configured to close the port for the battery chiller in an outdoor air cooling mode of the battery, and to close the port for the battery radiator in a chiller cooling mode or the temperature rise mode of the battery.

On the electric part cooling line, a second control valve is located at a point which is joined from a downstream point of the electric part radiator and the electric part chiller to upstream point of the electronic driving unit. The second control valve is configured to adjust flow of the cooling water introduced into the electronic driving unit by opening and closing the port for the electric part radiator or the port for the electric part chiller, depending on the thermal management mode of the electronic driving unit.

The second control valve is a three-way valve configured to close the port for the electric part chiller in the outdoor air cooling mode of the electronic driving unit, and to close the port for the electric part radiator in the electric part waste heat recovery mode of the electronic driving unit.

In an embodiment of the integrated thermal management circuit for a vehicle, a battery chiller and an electric part chiller are respectively provided or an integrated chiller integrating a battery chiller and an electric part chiller is provided to reduce the number of parts and reduce cost. Heating and battery temperature rise, etc. through a heat pump may be independently performed according to a thermal management mode for the vehicle through an accumulating unit provided with an accumulation unit, an expansion valve, and a refrigerant heater.

### BRIEF DESCRIPTION OF THE DRAWINGS

The above and other objects, features and other advantages of embodiments of the present disclosure will be more clearly understood from the following detailed description when taken in conjunction with the accompanying drawings, in which:

FIG. 1 is a diagram illustrating an integrated thermal management circuit for a vehicle according to one embodiment of the present disclosure;

FIG. 2 is a diagram of the integrated thermal management circuit of FIG. 1 illustrating that each of an electric part waste heat recovery mode, and an indoor heating and battery temperature rise mode, is performed in the integrated thermal management circuit for a vehicle according to one embodiment of the present disclosure;

FIG. 3 is a diagram of the integrated thermal management circuit of FIG. 1 illustrating that each of an outdoor air and electric part waste heat recovery mode, and an indoor heating and battery temperature rise mode, is performed in the integrated thermal management circuit for a vehicle according to one embodiment of the present disclosure; and

FIG. 4 is a diagram illustrating that a chiller unit consists of an integrated chiller in the integrated thermal management circuit for a vehicle according to another embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Specific structural and functional descriptions of the embodiments of the present disclosure disclosed in this disclosure or application are illustrative only for the purpose of describing the embodiments according to the present disclosure, and the embodiments according to the present disclosure may be implemented in various forms and should not be construed as being limited to embodiments described in this disclosure or application.

The embodiments according to the present disclosure may be variously modified and may have various forms, so that specific embodiments will be illustrated in the drawings and be described in detail in this disclosure or application. It should be understood, however, that it is not intended to limit the embodiments according to the concept of the present disclosure to specific disclosure forms, but it includes all modifications, equivalents, and alternatives falling within the spirit and scope of the present disclosure.

The terms first, second, and the like may be used to describe various components, but the components should not be limited by these terms. These terms may be used only for the purpose of distinguishing one component from another component, and, for example, a first component may be referred to as a second component, and similarly, the second component may also be referred to as the first component without departing from the scope of the present disclosure.

When a component is referred to as being “connected,” or “coupled” to another component, it may be directly connected or coupled to another component, but it should be understood that yet another component may exist between the component and another component. On the contrary, when a component is referred to as being “directly connected” or “directly coupled” to another, it should be understood that still another component may not be present between the component and another component. Other expressions describing the relationship between components, that is, “between” and “immediately between,” or “adjacent to” and “directly adjacent to” should also be construed as described above.

The terms used herein are for the purpose of describing only specific embodiments and are not intended to limit the present disclosure. Unless the context clearly dictates otherwise, the singular form includes the plural form. In this disclosure, it should be construed that the terms “comprising,” “having,” or the like are used to specify that a feature, a number, a step, an operation, a component, an element, or a combination thereof described herein exists, and they do not preclude the presence or addition of one or more other features, numbers, steps, operations, components, elements, or combinations thereof.

Unless defined otherwise, all terms including technical or scientific terms used herein have the same meaning as commonly understood by those skilled in the art to which the present disclosure pertains. General terms that are defined in a dictionary shall be construed to have meanings that are consistent in the context of the relevant art, and will not be interpreted as having an idealistic or excessively formalistic meaning unless clearly defined in this disclosure.

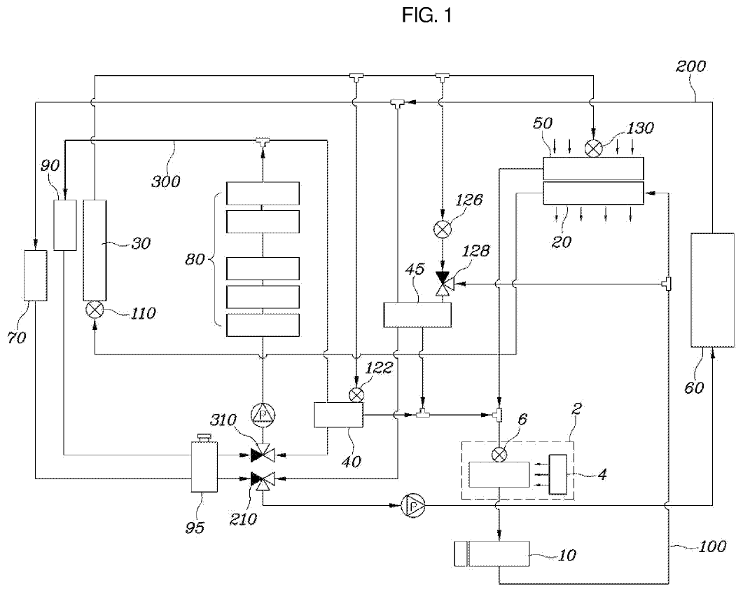

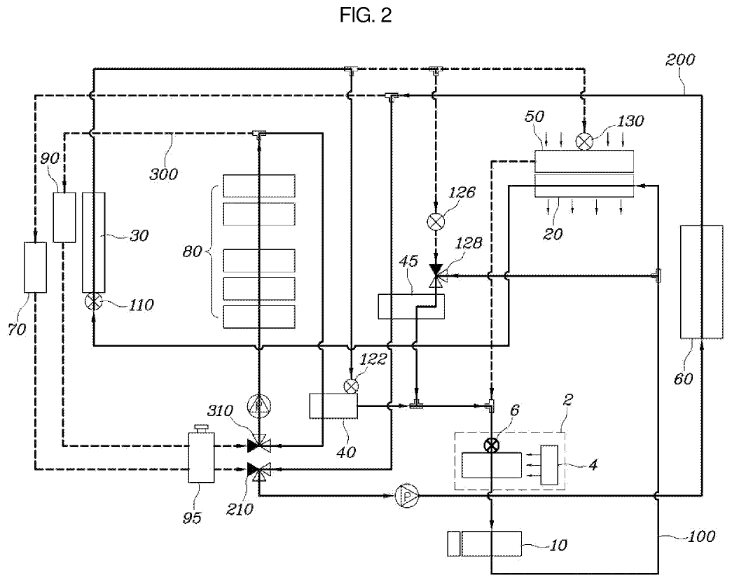

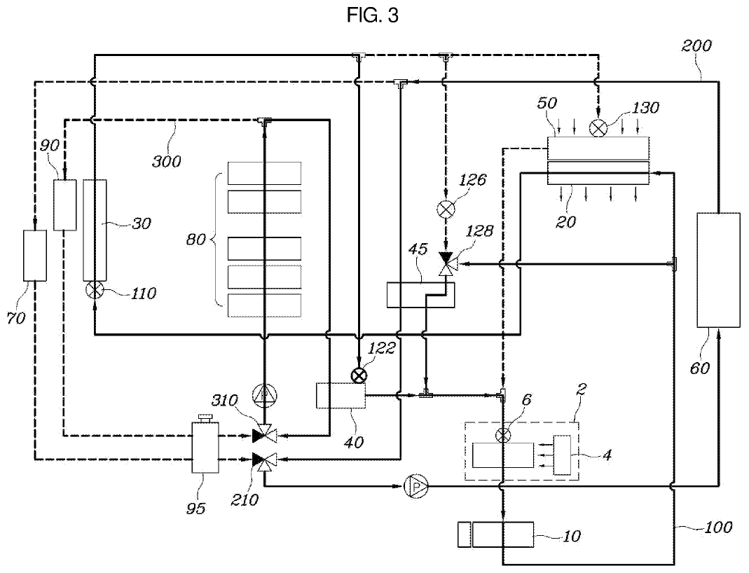

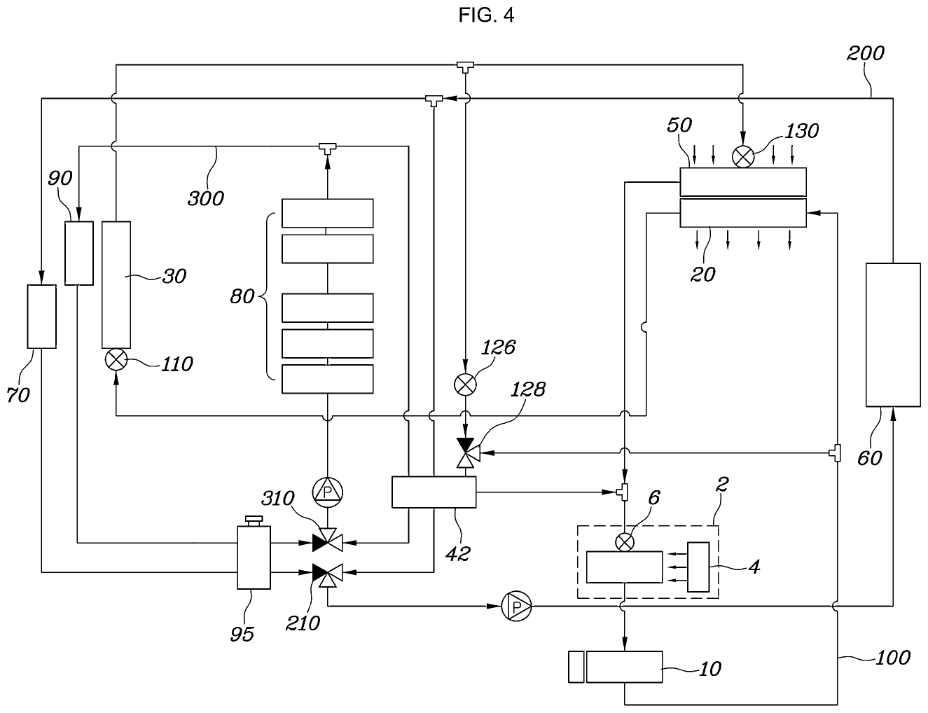

FIG. 1 is a diagram illustrating the integrated thermal management circuit for a vehicle according to one embodiment of the present disclosure. FIG. 2 is a diagram of the integrated thermal management circuit of FIG. 1 illustrating that each of the electric part waste heat recovery mode, and the indoor heating and battery temperature rise mode is performed in the integrated thermal management circuit for a vehicle according to one embodiment of the present disclosure. FIG. 3 is a diagram of the integrated thermal management circuit of FIG. 1 illustrating that each of an outdoor air and electric part waste heat recovery mode, and the indoor heating and battery temperature rise mode is performed in the integrated thermal management circuit for a vehicle according to one embodiment of the present disclosure. FIG. 4 is a diagram illustrating that the chiller unit consists of an integrated chiller in the integrated thermal management circuit for a vehicle according to one embodiment of the present disclosure.

With reference to FIG. 1, the integrated thermal management circuit for a vehicle according to the one embodiment of the present disclosure includes a refrigerant line 100 in which a refrigerant flows in the order of a compressor 10, an indoor condenser 20 of an indoor air-conditioning apparatus and an outdoor heat exchanger 30. The refrigerant discharged from the outdoor heat exchanger 30 is introduced into the compressor 10 after passing through a chiller unit or an evaporator 50 of the indoor air-conditioning apparatus. The integrated thermal management circuit also includes a battery cooling line 200 that circulates cooling water between a battery 60 and a battery radiator 70 or between the battery 60 and the chiller unit. The integrated thermal management circuit further includes an electric part cooling line 300 which circulates cooling water between an electronic driving unit 80 and an electric part radiator 90 or between the electronic driving unit 80 and the chiller unit. The integrated thermal management circuit additionally includes an accumulation unit 2 which is located at an upstream point of the compressor 10 on the refrigerant line 100, and includes an expansion valve 6 and a refrigerant heater 4. The accumulation unit 2 receives the refrigerant discharged from the chiller unit or the evaporator 50 and provides the received refrigerant to the compressor 10 or expands or heats the refrigerant and provides the expanded or heated refrigerant to the compressor 10.

In detail, in embodiments of the integrated thermal management circuit, the chiller unit may include an electric part chiller 40 and a battery chiller 45 that are connected in parallel. The cooling water of the battery cooling line 200 may be circulated through the battery chiller 45, and the cooling water of the electric part cooling line 300 may be circulated through the electric part chiller 40.

In embodiments of the integrated thermal management circuit, the refrigerant discharged from the compressor 10 on the refrigerant line 100 is branched for introduction into a temperature-rise control valve 128 which is located at an upstream point of the battery chiller 45. The temperature-rise control valve 128 may be configured to close a port for the outdoor heat exchanger 30 in a temperature rise mode of the battery 60.

Meanwhile, with reference to FIG. 4, in embodiments of the integrated thermal management circuit, the chiller unit may include an integrated chiller 42 which is formed with a plurality of flow paths. The cooling water of the battery cooling line 200, the cooling water of the electric part cooling line 300, and the refrigerant of the refrigerant line 100 may be circulated through the integrated chiller 42 through the respective independent flow paths.

In embodiments of the integrated thermal management circuit, the refrigerant discharged from the compressor 10 on the refrigerant line 100 is branched for introduction into the temperature-rise control valve 128 which is located at an upstream point of the integrated chiller 42. The temperature-rise control valve 128 may be configured to close a port for the outdoor heat exchanger 30 in the temperature rise mode of the battery 60.

In a conventional thermal management circuit including an integrated chiller having an electric part chiller integrated with a battery chiller, when temperature rise of a battery is performed through a water heater, heating through a heat pump using the waste heat of the electronic driving unit 80 cannot be performed. In this case, there is a problem in that indoor heating cannot help but depend on a positive temperature coefficient (PTC) heater 22 which has very low efficiency.

Also, since the water heater for raising the temperature of the battery and the PTC heater for indoor heating are respectively provided, costs increase and an assembly process is complicated. Further, when the heat pump is operated at a low outdoor air temperature (less than or equal to about −20 degrees), it is not possible to secure sufficient vapor refrigerant flow rate due to lack of the outdoor air heat or heat absorption performance. Thus, the further problem of deteriorating efficiency of the heat pump occurs.

Accordingly, in embodiments of the integrated thermal management circuit, unlike the conventional art, a refrigerant is directly heated through an accumulation unit which is integrated with the refrigerant heater 4. In this manner, both temperature rise of the battery 60 and indoor heating are performed. As a consequence, various effects such as cost reduction, weight loss, packaging benefit, and slimming of HVAC may be obtained.

In addition, through the introduction of the refrigerant heater 4, the heat pump may be operated through the waste heat of the electronic driving unit 80 even when the temperature of the battery 60 is raised. As a consequence, deteriorating thermal efficiency may be prevented and various thermal management modes may be independently performed. Furthermore, even at a low outdoor temperature, a liquid refrigerant may be vaporized by using the refrigerant heater 4, thereby providing the advantage that it is possible to maintain the performance and efficiency of the heat pump.

In other words, by controlling the accumulation unit 2 that includes the expansion valve 6 and the refrigerant heater 4, and the temperature-rise control valve 128 that is branched at a downstream point of the compressor 10 and is connected to an upstream point of the battery chiller 45 of the chiller unit or the integrated chiller 42, the battery temperature rise mode may be performed even without a water heater. Also, even when the battery temperature rise mode is performed, indoor heating through the heat pump may be independently performed by using the waste heat of the electronic driving unit 80.

On the other hand, in embodiments of the refrigerant line 100 of the integrated thermal management circuit, the expansion valve is located at an upstream point of the outdoor heat exchanger 30, an upstream point of the chiller unit or an upstream point of an evaporation line. The refrigerant, which passes through the expansion valve at the upstream point of the outdoor heat exchanger 30, the upstream point of the chiller unit or the upstream point of the evaporation line, may be selectively expanded depending on a cooling and heating mode of the vehicle.

FIG. 2 is a diagram of the integrated thermal management circuit of FIG. 1 illustrating that each of the electric part waste heat recovery mode, and the indoor heating and battery temperature rise mode, is performed in the integrated thermal management circuit according to one embodiment.

FIG. 3 is a diagram of the integrated thermal management circuit of FIG. 1 illustrating that each of an outdoor air and electric part waste heat recovery mode, and an indoor heating and battery temperature rise mode, is performed in the integrated thermal management circuit according to one embodiment.

When the battery temperature rise mode is performed in the battery cooling line 200, the electric part waste heat recovery mode of the electronic driving unit 80 is performed in the electric part cooling line 300, and the refrigerant line 100 may perform indoor heating through the waste heat of the electronic driving unit 80.

In detail, as illustrated in FIG. 2, when indoor heating through outdoor air heat absorption or indoor heating through the recovery of the electric part waste heat of the electronic driving unit 80 is performed, the accumulation unit 2 may heat the refrigerant which is introduced into the accumulation unit 2 through the refrigerant heater 4. In this case, the refrigerant is expanded through an expansion valve 110 which is located at an upstream point of the outdoor heat exchanger 30, and is introduced into the accumulation unit 2 after outdoor air heat absorption in the outdoor heat exchanger 30. Thereafter, the refrigerant introduced into the accumulation unit 2 is expanded even in the expansion valve 6 located at an upstream point of the accumulation unit 2, and is heated again by the refrigerant heater 4 to be supplied with insufficient quantity of heat.

As illustrated in FIG. 3, when both indoor heating and the temperature rise of the battery 60 through electric part waste heat recovery of the electronic driving unit 80 are performed together, the accumulation unit 2 may expand the refrigerant which is introduced into the accumulation unit 2 through the expansion valve 6. Then, the accumulation unit 2 may heat the expanded refrigerant through the refrigerant heater 4. In this case, the refrigerant is expanded through an expansion valve 122 which is located at an upstream point of the electric part chiller 40, and is introduced into the accumulation unit 2 after absorbing the waste heat of the electronic driving unit 80 in the electric part chiller 40. Even thereafter, the refrigerant introduced into the accumulation unit 2 is also expanded even in the expansion valve 6 located at upstream point of the accumulation unit 2, and the refrigerant is again heated by the refrigerant heater 4 to be supplied with insufficient quantity of heat.

In embodiments of the integrated thermal management circuit, on the battery cooling line 200, a first control valve 210 is located at a point which is joined from a downstream point of the battery radiator 70 and the battery chiller 45 to an upstream point of the battery 60. The first control valve 210 may be configured to adjust the flow of the cooling water which is introduced into the battery 60 via a reservoir 95, by opening and closing a port for the battery radiator 70 or a port for the battery chiller 45 depending on a thermal management mode of the battery 60.

In detail, in embodiments of the integrated thermal management circuit, the first control valve 210 may be a three-way valve, and it may be configured to close the port for the battery chiller 45 in an outdoor air cooling mode of the battery 60, and to close the port for the battery radiator 70 in a chiller cooling mode or the temperature rise mode of the battery 60.

In embodiments of the integrated thermal management circuit, on the electric part cooling line 300, a second control valve 310 is located at a point which is joined from a downstream point of the electric part radiator 90 and the electric part chiller 40 to an upstream point of the electronic driving unit 80. The second control valve 310 may be configured to adjust the flow of the cooling water introduced into the electronic driving unit 80 via the reservoir 95, by opening and closing the port for the electric part radiator 90 or the port for the electric part chiller 40 depending on the thermal management mode of the electronic driving unit 80.

In detail, in embodiments of the integrated thermal management circuit, the second control valve 310 may be a three-way valve, and it may be configured to close the port for the electric part chiller 40 in the outdoor air cooling mode of the electronic driving unit 80, and to close the port for the electric part radiator 90 in the electric part waste heat recovery mode of the electronic driving unit 80.

In conclusion, embodiments of the integrated thermal management circuit may, even without a water heater and a PTC heater according to the conventional art, implement various driving modes such as electric part outdoor air cooling, electric part waste heat recovery, battery outdoor air cooling, battery chiller cooling, and dehumidification, as in the conventional art by controlling the accumulation unit 2 consisting of the expansion valve 6 and the refrigerant heater 4, the temperature-rise control valve 128, the first control valve 210 and the second control valve 310. In addition, it is possible to maintain high thermal efficiency in the thermal management system of the vehicle by simultaneously implementing indoor heating through the battery temperature rise mode and the heat pump that is not possible in the conventional thermal management circuit.

While exemplary embodiments of the present disclosure has been illustrated and described, it will be apparent to those skilled in the art that the present disclosure may be variously improved and changed without departing from the technical spirit of the present disclosure provided by the appended claims

1. An integrated thermal management circuit for a vehicle, comprising:
a refrigerant line is configured to cause a refrigerant to flow in the order of a compressor, an indoor condenser of an indoor air-conditioning apparatus, and an outdoor heat exchanger, wherein the refrigerant discharged from the outdoor heat exchanger is introduced into the compressor after passing through a chiller unit or an evaporator of the indoor air-conditioning apparatus;
a battery cooling line configured to circulate cooling water between a battery and a battery radiator or between the battery and the chiller unit;
an electric part cooling line configured to circulate the cooling water between an electronic driving unit and an electric part radiator or between the electronic driving unit and the chiller unit; and
an accumulation unit, which is located at an upstream point of the compressor on the refrigerant line, includes an expansion valve and a refrigerant heater, and is configured to receive the refrigerant discharged from the chiller unit or the evaporator and provide the received refrigerant to the compressor or to expand or heat the refrigerant and provide the expanded or heated refrigerant to the compressor,
wherein the chiller unit includes an integrated chiller that is formed with a plurality of flow paths, and wherein the cooling water of the battery cooling line, the cooling water of the electric part cooling line, and the refrigerant of the refrigerant line are circulated through the integrated chiller through the respective independent flow paths.

2-4. (canceled)

5. The integrated thermal management circuit according to claim 1, wherein the refrigerant discharged from the compressor on the refrigerant line is branched for introduction into the temperature-rise control valve which is located at an upstream point of the integrated chiller, and the temperature-rise control valve is configured to close a port for the outdoor heat exchanger in the temperature rise mode of the battery.

6. The integrated thermal management circuit according to claim 1, wherein, in the refrigerant line, the expansion valve is located at an upstream point of the outdoor heat exchanger, an upstream point of the chiller unit or an upstream point of an evaporation line, and the refrigerant, which passes through the expansion valve of the upstream point of the outdoor heat exchanger, the upstream point of the chiller unit or the upstream point of the evaporation line, is selectively expanded depending on a cooling and heating mode of the vehicle.

7. The integrated thermal management circuit according to claim 1, wherein, when the battery temperature rise mode is performed in the battery cooling line, the electric part waste heat recovery mode of the electronic driving unit is performed in the electric part cooling line, and the refrigerant line performs indoor heating through the waste heat of the electronic driving unit.

8. The integrated thermal management circuit according to claim 1, wherein, when indoor heating through outdoor air heat absorption or indoor heating through the recovery of electric part waste heat of the electronic driving unit is performed, the accumulation unit heats the refrigerant which is introduced into the accumulation unit through the refrigerant heater.

9. The integrated thermal management circuit according to claim 1, wherein, both indoor heating and temperature rise of the battery through electric part waste heat recovery of the electronic driving unit are performed together, after the accumulation unit expands the refrigerant that is introduced into the accumulation unit through the expansion valve, and after the accumulation unit heats the expanded refrigerant through the refrigerant heater.

10-13. (canceled)
